(19) United States
(12) Patent Application Publication
(10) Pub. No.: US 2011/0196725 A1
(43) Pub. Date: Aug. 11, 2011

(54) SYSTEM AND METHOD FOR AWARDING CUSTOMERS FOR REFERRALS

(75) Inventors: Jasper Malcolmson, San Francisco, CA (US); Ashish Baldua, San Jose, CA (US)

(73) Assignee: VALUESCOUT, INC., Mountain View, CA (US)

(21) Appl. No.: 12/702,800

(22) Filed: Feb. 9, 2010

(51) Int. Cl. G06Q 30/00

(52) U.S. Cl. 705/14.16

(57) ABSTRACT

This invention discloses a novel system and method for implementing an electronic customer referral service that both checks that the new customer is distinct from the referring customer and tracks the referral so that the old customer gets credit for their referred new customer's action.

### FIELD OF INVENTION

The invention provides a system for merchants to provide a promotional incentive to customers to initially try the services of a local merchant, then refer other individuals, and then repeat usage of the merchant's services. The referrals are made electronically using any kind of data networked communication protocol, for example, email, Twitter™, instant messaging, texting and the like. In one embodiment, the service operates with Internet-based vendors. In another embodiment, the service operates with so-called “brick and mortar” stores using uniquely identifiable coupons. In yet another embodiment, the service is operated as a third party to the transaction between the vendor and the customer. In yet another embodiment, the service is provided to the vendor as a software product that can be operated by the vendor.

### BACKGROUND

It is well known that a vendor often rewards a customer for their own frequent purchasing or use of the vendor's goods or services. It is also known that vendors will offer a discount to a first-time customer in order to promote new business. However, there is a need for a system to offer a referral award to a first customer for referring a second new customer or a predetermined number of new customers. In one embodiment, the system permits a vendor to offer a varied threshold of success for the referring customer. For example, the vendor can set a threshold for the number of new customers generated by the first customer's referrals. However, there is a need for a system and method that prevents a customer that pretends that they are the new customer and thereby receive the same first-time discount a second time or to receive the reward for meeting the threshold requirement of referrals. There is also a need for the referral system to track the referral process so that a new customer is automatically associated with the source of the referral. The system includes data storage and analysis systems and processes that check whether or not it is likely that a referred customer is in fact an instance of the first customer.

### DESCRIPTION OF THE FIGURES

1. Basic System Architecture

2. Basic Flow Chart for Server Activity

3. Example Webpage Presented to First Users

4. Example Webpage Presented to Second User

5. Example Webpage Presented to First User When Threshold of Referrals Has Been Reached

6. Flow Chart for Checking Transaction Status

7. Flow Chart for Retrieving Information about New User

8. Flow Chart for E-Mail Match Lists

### DETAILED DESCRIPTION OF THE PREFERRED EMBODIMENTS:

The system operates on a computer, typically a file server connected to the Internet. Specific embodiments for the equipment and data network are discussed below. In one embodiment, the protocol for communication is by email, and the invention will be explained in the context of an email system. However, the invention is not limited to email communication and can include any kind of data communication or messaging service, including texting, Twitter™, instant messaging and the like. All that is necessary is that one user's computing device transmit a data message to a second user's device carrying at least a unique identifier. A user's computer can be a personal computer, mobile phone, mobile handheld device like a Blackberry™ or iPhone™ or any other kind of computing device a user can use to send and receive data messages.

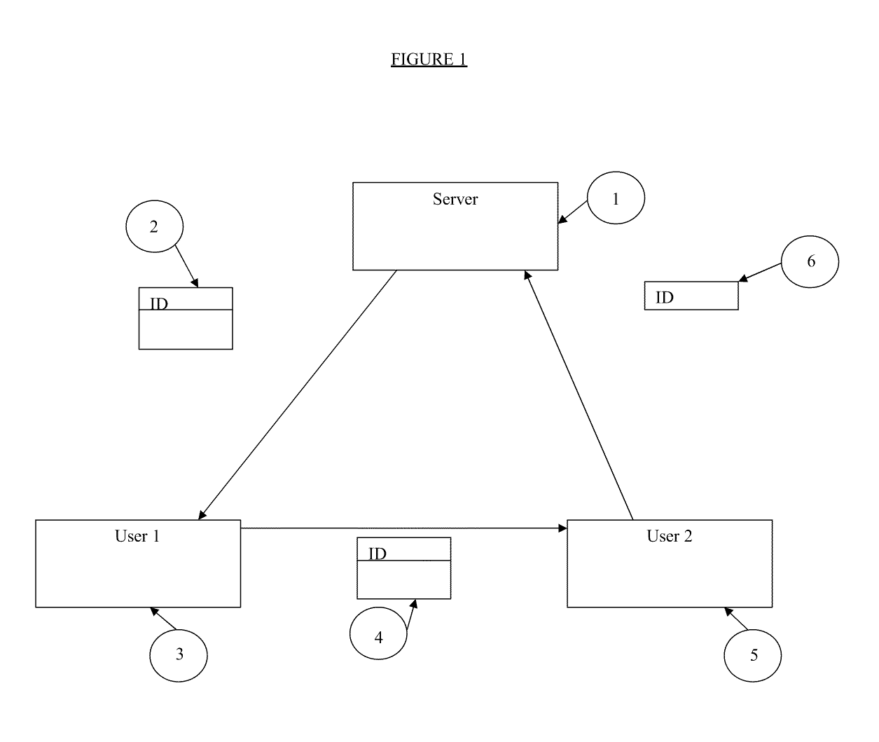

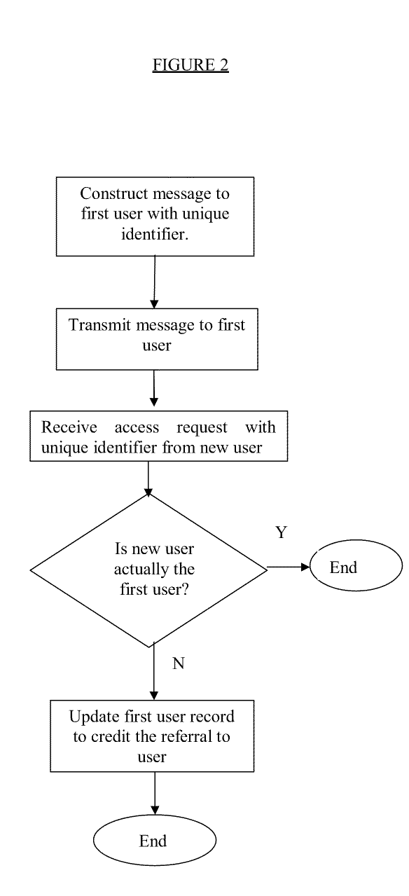

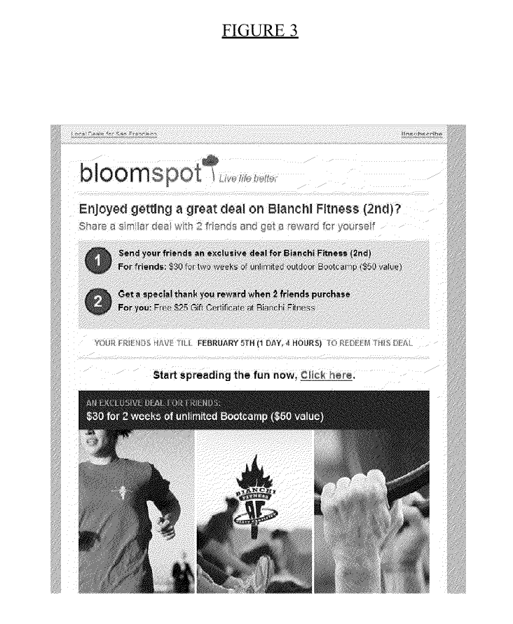

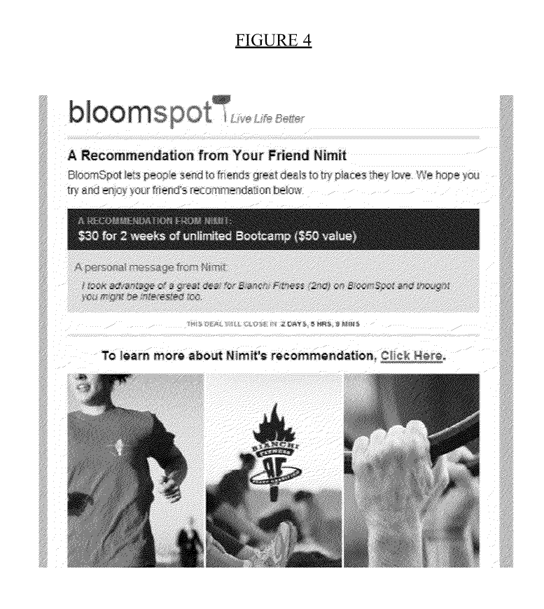

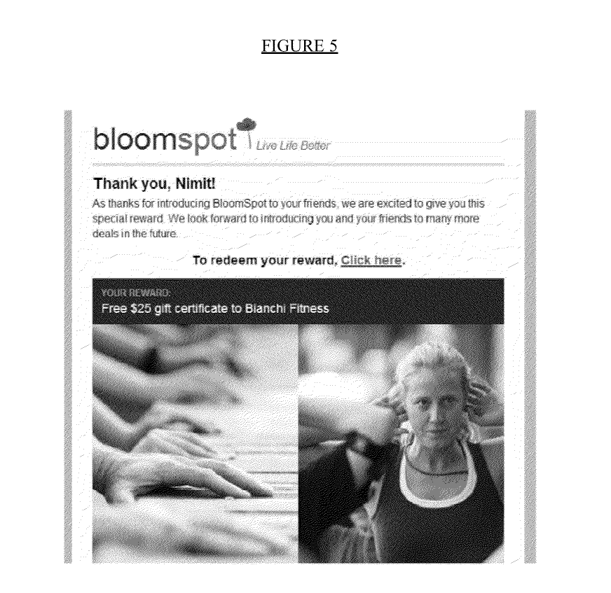

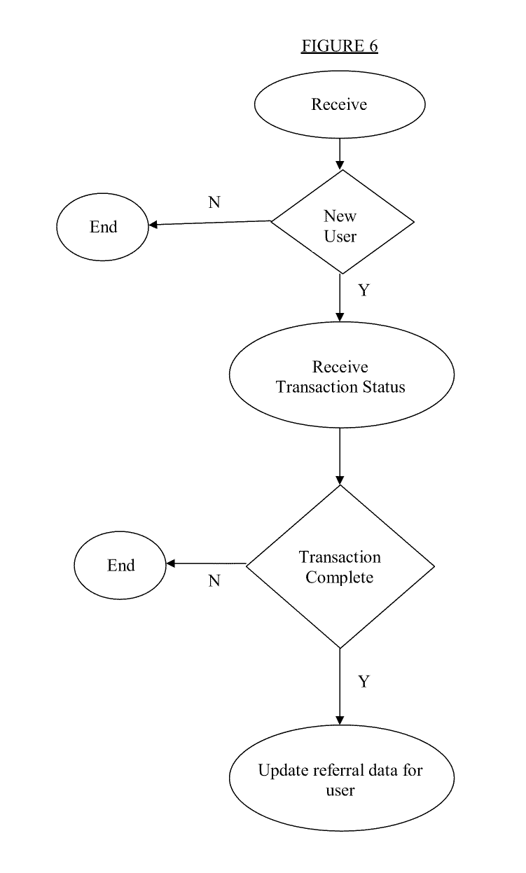

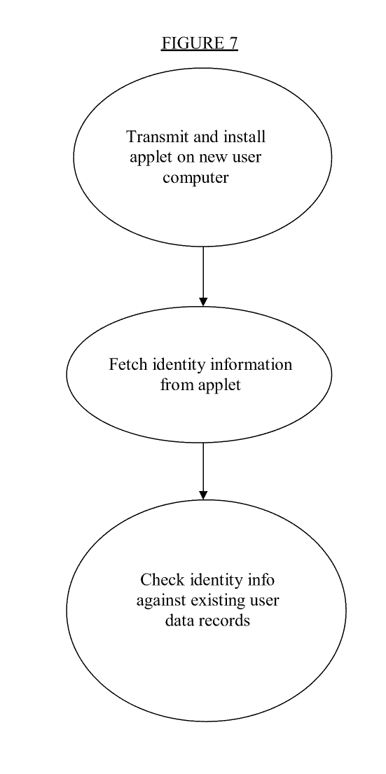

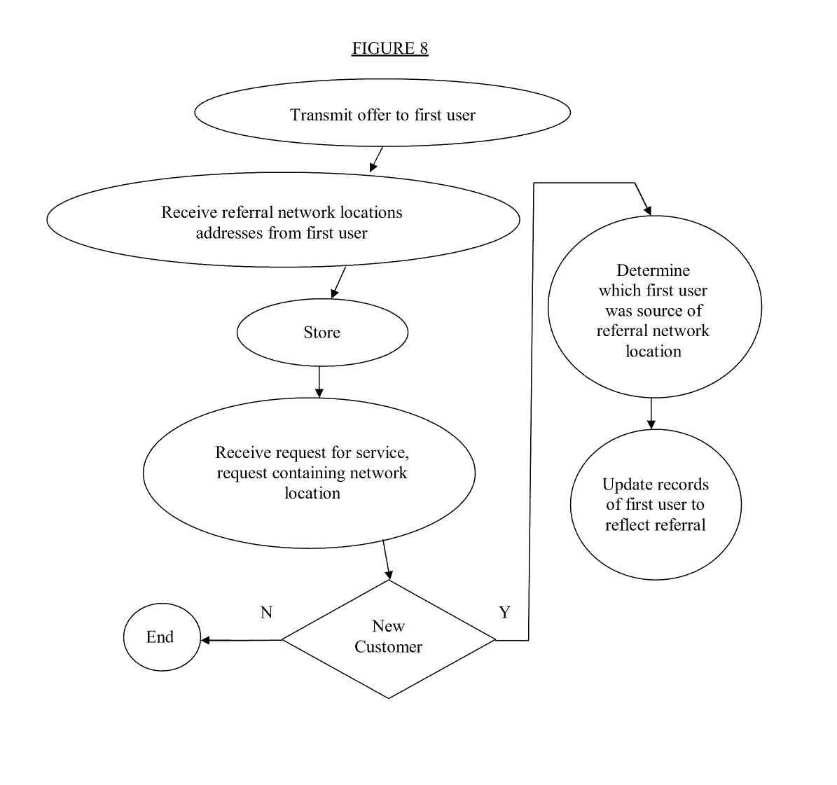

Referring now to FIG. 1, the server (1) hosting the service will transmit a first data message (2) to the first user (3), which in the typical embodiment will be an email. Typically, the service already has the email address and possibly other information about the first user because they are already a customer of the service. The server will contain or have access to a database that stores the information associated with the first user. In a second embodiment, this information is stored on the servers of a vendor, operatively connected to the service through a data network. In this second embodiment, the service receives a list of email addresses from the vendor, each address typically being an existing customer of the vendor.

The first data message contains a unique identifier. (6) The identifier is associated with the specific recipient of the email message. In other words, for N recipients of the data message or a given promotion, there will be N distinct identifiers. This ensures that each referral can be tracked by recipient user. The email will contain other text offering the recipient user a reward if a predetermined number of referrals are generated by the recipient user. In another embodiment, the message has a hyperlink that causes a webpage to be displayed. In one embodiment, the recipient user then forwards the message on to one or more potential referrals, with the unique identifier that is embedded in the message. The potential referrals that act on the referral, referred to here as the second user, will then access the service directly.

When the second user accesses the service, the unique identifier is input into the service's system operating on the server. When the system receives such an access request, the system obtains the unique identifier and using standard database searching techniques, recovers from the user database the identity of the referring first user. The data record associated with the first user can be updated to reflect the successful referral.

In one embodiment, the database architecture assumes that the service will work with multiple vendors and a given first user may also work with multiple vendors. Therefore, the database record associated with the first user will have an entry for each vendor using the service and the unique identifier will be associated with both the first user and which vendor's offer the first user is referring out. In yet another embodiment, a vendor may want to have several outstanding offers for referral business. In this case, the database records will include for each first user, not only which vendor but which offer the vendor has instituted, and the unique identifier will map to that specific offer for that vendor for that first user.

### Enterprise Syndication:

There are several embodiments that provide the service for vendors. In one embodiment, a vendor provides the service a list of email addresses or other indicia of network location. These can include phone numbers, Twitter™ usernames and the like. The service generates the individual identifiers and transmits the email offers to the set of first users at their designated network location, e.g. e-mail address, Twitter™ account or phone number. The set of new users visit a webpage on the services website that is branded with the vendor's brand. The service receives the unique identifier and updates a database whose records correspond to the email addresses provided as a data element of each data record of the first set of users. Once one or more of the set of first users reach the predetermined threshold for referrals, this information is transmitted as data back to the vendor and the vendor can either update a database to update a database indication that the first user has earned a reward, typically by encoding the credit associated with the reward or transmit an electronic coupon to these first users or both. In another embodiment, the service provides a set of unique identifiers to the vendor and the vendor transmits out the messages to the set of first users at the network locations it has. In that case, the set of new customers come to the branded webpage operated by the service and the service updates its own database and issues to the set of first users who have reached the predetermined number of referrals an electronic discount coupon that can be used with the vendor. In this case the vendor transmits data representing one or more reward coupons to the service.

In yet another embodiment, the set of first users receive notification that the promotion is being run, and then they visit the website of the service, using an Internet browser or similar tool. At that website, the set of first users input network locations, e.g. email addresses, of potential new customers. The service sends promotional offers out to these prospective new customers that contain a unique identifier that can be mapped to the first user who input the email address.

In yet another embodiment, the set of first users receive from the vendor notification that the promotion is being run and the set of first users visit the vendor's website. The set of first users input email addresses of potential new customers into the vendor's website. In one version of this embodiment, the service provides a set of unique identifiers to the vendor and the vendor sends out the promotion to the potential new customers. In another version, the email addresses are provided to the service and the service sends out the emails to the prospective new customers.

In yet another embodiment, there may be additional interaction between the service and the vendor. If the vendor wants to be sure that a transaction with a new customer has occurred prior to issuing the reward, then the vendor will store the unique identifier it receives from the new customer in a database if a transaction is completed. That data record will also contain data indicating that the new customer actually completed a transaction. Similarly, the vendor can notify the service of unique identifiers associated with confirmed transactions. At some point, the database will be searched for unique identifiers associated with completed transactions. Those unique identifiers and the number of transactions associated with them will be provided to the service.

Practitioners of ordinary skill will recognize that these variations accommodate offering the invention as a service to on-line merchants. The same invention can be configured where the vendors performs all of the steps in the invention described above, including maintaining the databases.

### Checking Uniqueness of the New Customer:

It is recognized that a single person may have several email addresses or other network locations. Therefore, the system could be susceptible to fraud in the sense that a first user may decide to include one or more email addresses or network locations that in fact belong to the first user, but at a different address. Therefore, the system operates processes to check that a potential new customer is not likely to be a first user with a new email address or other network location. In one embodiment of the invention, the service will collect information from the first users. This information will be from two categories.

The first category is the credit card information the first user used to purchase the first time, email address and telephone number. The second category is the Internet IP address associated with the computer the first user used and a tracking code associated with that computer. This information is stored with the data record associated with the first user. In this embodiment, a potential new customer is deemed actually a first user not eligible for the promotion if one piece of information from both categories match a first user in the database. If not, the potential new customer is deemed to be a bona-fide new customer.

By looking at some of the pieces of information collected the system can analyze these in order to determine with various levels of confidence that the visitor is in fact a unique new customer. Depending on this level of confidence various actions can be taken: sending an alert to the system to flag the transaction for a potential re-use, 2) warning the user about potential re-use or 3) rejecting the purchase unless the user can verify that they are a unique new customer.

There are some pieces of information about a single visitor to the website than can be acquired which result in multiple visitors being treated as the same customer. These items include:
the visitor's email address or other network location
phone number
credit card information.

There are others pieces of information about the visitor that are not individually sufficient evidence that the visitor is the same customer, but when used together will produce various levels of confidence about the customer's uniqueness. These items include:
the visitor's computer (as identified by browser & flash cookies, HTTP user agent information, browser/OS version)
the visitor's billing address
the visitor's network information (where they are connecting from: IP address, ISP)
referral tracking codes (how the user arrived on the website using tracking codes on emails and 3rd party sites)

Although it's difficult to determine if two people are uniquely different, it is actually much easier to determine if two people are the same. If one or more of the methods below are used to identify a user across multiple unknown mediums, the system will review the data associated with two or more allegedly unique users. The data review can include collecting statistics to determine the likelihood that two allegedly distinct persons are different based on the measured similarity of data collected about them. This system can be used to require only “new users” from accessing the service as a new user.

For example if two people both log into the same account from two separate IP addresses with the same unique cookie, one can conclude that that user ‘owns’ both IP addresses. If there is then a “new user” coming from one of these new IP addresses it is more suspicious that they are in fact the original user attempting to bypass the “new user” requirement. As people use the service website over time a database can store for each user a list of the various mediums, and end points that they connect to the service and apply inferential statistics in order to determine if two customers are in fact the same person.

The method for checking that the new customer is new, not a first user, uses a combination of the following methods:
analyzing user payment method information including credit card number, type of credit card, type of payment method
analyzing results from an address verification system
using social relations and connections to 3rd party authentication systems in order to link accounts and identify similar users
using end user/client hardware to access location specific information via GPS
identifying the user by their billing information including billing address, phone number, confirmation email address
using HTTP cookies in order to uniquely identify the web browser.
using FLASH cookies in order to uniquely identify a computer since the FLASH cookie is shared among browsers and is not removed by the normal processes. This can be done by embedding a hidden flash movie using the IP address to identify the network connection/endpoint using network information (end user network, subnet, ISP information)
using network characteristics (network latency, connecting path through the network from the server to the client)
using end user software or client-based software that is installed on the customer's computer/network/client device
identifying user via system information sent via http such as the user agent, time zone, operating system version
requiring biometric information submitted by end user software or via a web interface, for example using a computer's camera to take a picture and using facial recognition or retina recognition technology that checks whether the face is already in the first user database. Another example is using voice recognition technology via microphone via web interface.
analyzing the user's social graph and tracking the source of the user's subscription/referral. In this example, the email addresses submitted by the first user are checked against email addresses submitted by a purported new customer that decides to also conduct a promotion. In that case, the two lists of email addresses can be compared.
tracking past sales history of the user, cookie/browser, computer/IP address, and/or network connection
tracking network usage via 3rd parties, ad networks, affiliates
integrating merchant specific information: customer information, sales history
using end user/client software to grab hardware specific information. In this case, the browser will run an applet that fetches serial number information from the CPU chip, disk drive configuration data and the like.
quantitative analysis of end user input, interpreting gestures, calculating timing between inputs and/or response time
Flash Cookies (shared objects): similar to normal browser cookies, ad companies and widget companies often set cookies in flash which can be used to identify a user.
Checking browser DOM: Another way to identify a repeat user is by creating a hash out of a number of different browser related variables that user will have on their machine that a browser applet can access:
plug-in versions of things like flash, quicklime, java, browser version, etc.
dom methods available (more for strong browser detection)
The plug-in version technique could be used across browsers and can be more reliable than IP address which can easily change. This hashed value can be stored in the service database and associated with a first user. If a purported new user accesses the service with the same information, it can indicate a fake new user.

In the embodiment that operates as a service for multiple vendors, the database that stores records associated with first users and new customers or new users typically will include an entry that associates the “old customer” or “new customer” with a vendor using the service. That is because a vendor's offer to provide a reward for a referral of bona fide new customers may refer to new customers of the vendor, not new customers of the service. The point is that a vendor may want to take advantage of a large pool of users of a service that routinely refer other users of the service who may not yet use or buy from that particular vendor.

“Cookies” or “Tracking cookies” are known in the art as a small data file that a website can create and cause to be downloaded and stored on a website visitor's computer. The website server can create the data payload based on information that it retrieves or senses from computer visiting the website. This also can include reference numbers that cross references to data that the server stores about that particular interaction with that user. The next time the user visits that website, or even another website, the website the user is visiting can retrieve that data item from the user's computer, and use that data to cross reference the information about the earlier website visit. Further information regarding “cookies” can be found in U.S. Pat. No. 6,374,359 to Shrader, et. al., which is incorporated herein by reference.

This technique lets a website track what a user is doing with their web browser. In this case, the tracking cookies can be used to check the status of a user as a “new customer” or not. The cookie data can include a list of vendors that the browser or computer (i.e. the user) is already associated with, and for which the user shall be deemed not a new user.

### Tracking Referrals to First Users:

There are several ways that the unique identifier comprising the invention can be embodied. In the examples presented above, the notion was an alphanumeric object contained in an email. In one embodiment, the object is a number, which can be digitally signed using standard cryptographic techniques to verify that it has not been tampered with. In that embodiment, the prospective new customer will input the number. The service will run well-known numerical techniques to confirm that the number has not been tampered with. A portion of or all of the number is used to map the first user that referred the individual. These numbers can be used to track who the first user sent the offer to, and which potential new customer acted on the offer.

Additional embodiments for the unique identifier are described below:
The system can request through a webpage the new customer, the email address, network location, and/or name of the person who referred them.
Hyperlink tracking: embedding codes in the URL which is placed over the promotional email or data message that uniquely identify the person sending the referral and the new customer making the referral purchase.
Linking the two via email addresses, for example: evan@bloomspot.com sends an email to jasper@bloomspot.com, an unknown user with the email address jasper@bloomspot.com, makes the purchase, we look back to see who sent out a referral to jasper@bloomspot.com and identify the referrer as evan@bloomspot.com. In this case, in lieu of a unique identifier the relationship is tracked by reviewing where email addresses were obtained.
Linking the two via phone number, for example: Evan sends a message to BloomSpot letting BloomSpot know that he wants to send a referral message via SMS, Evan submits Jasper's phone number as the person he'd like to send it to. During the check out an unknown user submits Jasper's phone number as their own phone number, the system looks in the database to check if anyone has sent a referral message to this phone number, the system can determine that Evan did, and then credit him with the referral.
The system can use the physical device identifier such as an iPhone ID, BlueTooth ID, or MAC address in order to identify the hardware that initiated the referral and the hardware that claimed the referral.

In yet another embodiment, the promotional email contains a URL (Universal Resource Locator) that is unique to the offer. Prior to transmission, the service can automatically create a webpage associated with that URL, typically containing the point of sale for the offer. The URL can contain the unique numeric identifier. The recipient, that is, the prospective new customer, receives the email and can click on the URL link using a standard web browser. The web browser will then display the webpage. At the same time, the server can retrieve from the URL the text string constituting the unique identifier. In this manner, the prospective customer does not have to actually input any data at all.

### Operating Environment:

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer may be a laptop or desktop type of personal computer. It can also be a cell phone, smart phone or other handheld device. The precise form factor of the user's computer does not limit the claimed invention. In one embodiment, the user's computer is omitted, and instead a separate computing functionality provided that works with the central server. This may be housed in the central server or operatively connected to it. In this case, an operator can take a telephone call from a customer and input into the computing system the customer's data in accordance with the disclosed method. Further, the customer may receive from and transmit data to the central server by means of the Internet, whereby the customer accesses an account using an Internet web-browser and browser displays an interactive webpage operatively connected to the central server. The central server transmits and receives data in response to data and commands transmitted from the browser in response to the customer's actuation of the browser user interface.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. Method of providing a customer reward comprising:
Transmitting to a first customer an offer of the customer reward, said offer containing a predetermined numeric value representing the number of purchasers said first customer must refer in order to receive the reward;
Receiving from a plurality of individuals a corresponding plurality of data messages representing a corresponding plurality of purchases by such individuals;
For each first customer, determining the number of such plurality of individuals referred by the first customer;
Transmitting to the first network location a data message representing the reward.

2. Method of providing a customer reward comprising:
Transmitting to a first customer an offer of the customer reward, said offer containing a predetermined numeric value representing the number of purchasers said first customer must refer in order to receive the reward;
Receiving from a plurality of individuals a corresponding plurality of data messages representing a corresponding plurality of purchases by such individuals;
updating a data record in a database associated with the first customer to include data representing that the referral has occurred.

3. Method of claim 1 further comprising:
Transmitting to the first user data representing a reward, for example pay pal money, coupon number, notice that a credit has been awarded.

4. The method of claim 1 further comprising:
Determining that the first customer and any of the plurality of individuals are not the same.

5. The method of claim 4 where the Determining step comprises the steps of:
Sensing the IP address of the first customer and the plurality of individuals;
Comparing the IP address of the first customers with the plurality of IP addresses of the plurality of individuals.

6. Method of providing a customer reward comprising:
Transmitting to a first network location a data message, said data message containing a unique identifier associated with said first network location;
Receiving from a plurality of second network locations the unique identifier;
Mapping the unique identifier to a particular data record in a database;
Updating a value in the data record representing the number of referrals associated with the first network location.

7. The method of claim 6 further comprising:
Determining that the updated value equals or exceeds a predetermined numeric threshold;
Transmitting to the first network location a data message representing the reward.

8. The method of claim 7 further comprising:
Updating the data record in the database associated with the first network location to include data representing that the reward had been issued.

9. The method of claim 6 further comprising:
Determining that the first network location and any of the plurality of second network locations are not associated with the same individual.

10. The method of claim 9 where the Determining step comprises the steps of:
Sensing the IP address of the first network location and the plurality of second network locations;
Comparing the IP address of the first network location with the plurality of IP addresses of the plurality of second network locations.
